(19) United States
(12) Patent Application Publication
(10) Pub. No.: US 2016/0353173 A1
(43) Pub. Date: Dec. 1, 2016

(54) VOICE PROCESSING METHOD AND SYSTEM FOR SMART TVS

(71) Applicant: ALIBABA GROUP HOLDING LIMITED, George Town, Grand Cayman (KY)

(72) Inventors: Wuping DU, Hangzhou (CN); Kunyong CAO, Hangzhou (CN)

(73) Assignee: ALIBABA GROUP HOLDING LIMITED, George Town, Grand Cayman (KY)

(21) Appl. No.: 15/112,805

(22) PCT Filed: Jan. 16, 2015
(86) PCT No.: PCT/CN2015/070860

§ 371 Date: Jul. 20, 2016

(30) Foreign Application Priority Data
Jan. 23, 2014 (CN) 201410032635.X

(51) Int. Cl. H04N 21/478; H04N 21/439; H04N 21/81; H04N 21/422

(52) U.S. Cl. CPC H04N 21/478; H04N 21/42203; H04N 21/439; H04N 21/8173

(57) ABSTRACT

Disclosed are systems and methods for improving interactions with and between computers in content communicating, rendering, generating, hosting and/or providing systems supported by or configured with personal computing devices, servers and/or platforms. The systems interact to identify and retrieve data within or across platforms, which can be used to improve the quality of data used in processing interactions between or among processors in such systems. The present disclosure discloses voice processing systems and methods for smart TVs. The voice processing systems and methods initiates, via a smart TV, a wireless voice channel whereby the smart TV receives voice signals through the voice channel. The smart TV then determines a current application scenario and performs corresponding processing on the voice signals according to the application scenario. The determination of voice processing within the application scenario enables interaction with the smart TV over the wireless voice channel.

### CROSS-REFERENCE TO RELATED APPLICATIONS

This application claims the benefit of priority from Chinese Patent Application No. 201410032635.X, filed on Jan. 23, 2014 and PCT Application No. PCT/CN2015/070860, filed on Jan. 15, 2015,” which are incorporated herein in their entirety by reference.

### TECHNICAL FIELD

The present disclosure relates to smart TV technology, and specifically to providing non-native functionality to Smart TV systems and platforms for voice processing.

### BACKGROUND

Recent developments in televisions and smart televisions (TVs) have enabled traditional functions such as video playing, gaming and the like on TVs. A smart TV also has network connectivity functionality, and is able to conduct cross-platform searches through the TV, the network, and software applications. The smart TV is becoming a third information access terminal following computers and mobile phones, which allows users to access network information through the smart TV.

However, the voice input device is not yet a standard configuration in a smart TV. If it is desired to configure a smart TV with a voice input, a user has to purchase an additional voice input device. As a result, the user needs to pay additional costs. Moreover, the voice input device and the smart TV are mostly connected by a cable, thereby greatly restricting transmission distance.

In summary, shortcomings in the prior art evidences a technical problem that a voice input device currently cannot be efficiently and cost-effectively configured with voice input.

### SUMMARY

According to some embodiments of the present disclosure, disclosed systems and methods provide voice processing functionality for smart TVs.

According to some embodiments of the present disclosure, a voice processing method for smart TVs is provided, comprising: the smart TV initiating a wireless voice channel; the smart TV receiving voice signals through the voice channel; and the smart TV determining a current application scenario and correspondingly processing the voice signals according to the application scenario.

According to some embodiments, if it is determined that the current application scenario of the smart TV is a first application scenario, the voice signals are processed according to the application scenario, which comprises: the smart TV recognizing the voice signals through a voice recognition technology, converting the recognized voice signals into a corresponding operation command, and executing the operation command by the smart TV; wherein the operation command is an operation command corresponding to a remote control for the smart TV.

According to some embodiments, recognition of the voice signals through a voice recognition technology, and the conversion the recognized voice signal into a corresponding operation command comprises: extracting voice features of the voice signals; finding a match for the voice features in a preset voice feature database to obtain a matching result, and converting the matching result into a corresponding operation instruction, wherein corresponding relations between voice features and operation instructions are stored in the voice feature database.

According to some embodiments, if it is determined that the current application scenario of the smart TV is a second application scenario, the voice signals are processed according to the second application scenario, which comprises: the smart TV recognizing the voice signals through a voice recognition technology, finding a match for the recognized voice signals in a preset voice feature database to obtain a matching result, and executing the matching result by the smart TV.

According to some embodiments, if it is determined that the current application scenario of the smart TV is a third application scenario, the voice signals are processed according to the third application scenario, which comprises: playing the voice signals through a sound card of the smart TV.

According to some embodiments, the smart TV's initiating of a wireless voice channel comprises: the smart TV initiating a wireless voice channel between the smart TV and a mobile terminal; and the smart TV's receiving of voice signals through the voice channel, which comprises: the smart TV receiving voice signals from the mobile terminal through the voice channel.

According to some embodiments, the method further comprises the step of the mobile terminal acquiring voice signals through its microphone; or the mobile terminal receiving the voice signals.

According to some embodiments of the present disclosure, a smart TV is provided, the smart TV comprising: an establishing module configured for initiating a wireless voice channel; a receiving module configured for receiving voice signals through the voice channel; and a processing module configured for determining a current application scenario of the smart TV, and processing the voice signals according to the application scenario.

According to some embodiments, if it is determined that the current application scenario of the smart TV is a first application scenario, the processing module is further used for recognizing the voice signals through a voice recognition technology, converting the recognized voice signal into a corresponding operation command, and executing the operation command by the smart TV; wherein the operation command is an operation command corresponding to a remote control for the smart TV.

According to some embodiments, the processing module comprises: a feature extracting module configured for extracting voice features of the voice signals; and a matching module configured for finding a match for the voice features in a preset voice feature database to obtain a matching result, and converting the matching result into a corresponding operation instruction, wherein corresponding relations between voice features and operation instructions are stored in the voice feature database.

According to some embodiments, if it is determined that the current application scenario of the smart TV is a second application scenario, the processing module is further used for recognizing the voice signals through a voice recognition technology, finding a match for the recognized voice signals in a preset voice feature database to obtain a matching result, and executing the matching result by the smart TV.

According to some embodiments, if it is determined that the current application scenario of the smart TV is a third application scenario, the processing module is further used for playing the voice signals through a sound card of the smart TV.

According to some embodiments of the present disclosure, a voice processing system for smart TVs is provided, comprising: a smart TV, and the system further comprises a mobile terminal, where the mobile terminal is configured for acquiring voice signals through its microphone or receiving the voice signals.

In accordance with one or more embodiments, a non-transitory computer-readable storage medium is provided, the non-transitory computer-readable storage medium tangibly storing thereon, or having tangibly encoded thereon, computer readable instructions that when executed cause at least one processor to perform a method as discussed herein.

In accordance with one or more embodiments, a system is provided that comprises one or more computing devices (also referred to as a “device”) configured to provide functionality in accordance with such embodiments. In accordance with one or more embodiments, functionality is embodied in steps of a method performed by at least one computing device. In accordance with one or more embodiments, program code (or program logic or computer-executable instructions) is executed by a processor(s) of a computing device to implement functionality in accordance with one or more such embodiments is embodied in, by and/or on a non-transitory computer-readable medium.

According to the above technical schemes of the present disclosure, voice signals are received through the established voice channel, and the voice signals are processed according to the current application scenario, so as to realize the interaction with a smart TV and greatly improve the user experience of smart TVs.

### BRIEF DESCRIPTION OF THE FIGURES

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a flow diagram of the voice processing method for smart TVs according to some embodiments of the present disclosure;

FIG. 2 is a flow diagram of the voice processing method for smart TVs according to some embodiments of the present disclosure;

FIG. 3 is a block diagram of the smart TV according to some embodiments of the present disclosure; and

FIG. 4 is a block diagram of the smart TV according to some embodiments of the present disclosure.

### DETAILED DESCRIPTION

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which executed via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer to alter its function, a special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. As discussed below, computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a wired or wireless line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations. For example, a smart phone, phablet or tablet may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows®, iOS® or Linux®, or a mobile operating system, such as iOS, Android®, or Windows® Mobile, or the like.

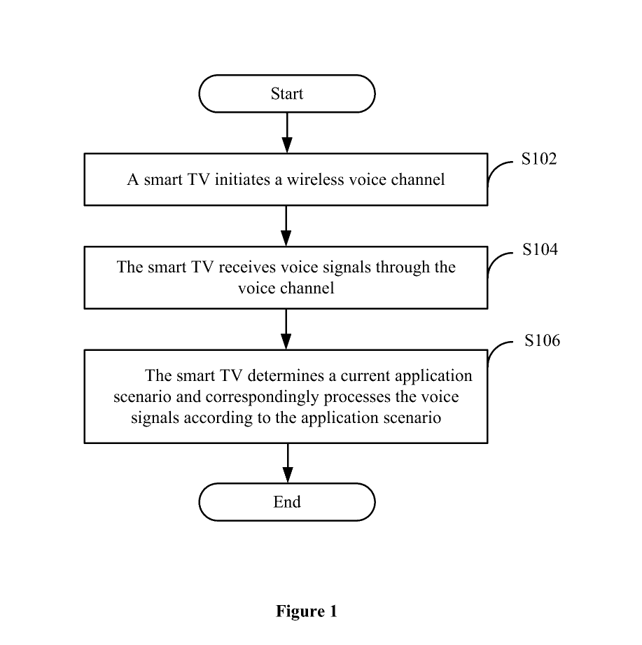

A client device may include or may execute a variety of possible applications, such as a client software application enabling communication with other devices, such as communicating one or more messages, such as via email, short message service (SMS), or multimedia message service (MMS), including via a network, such as a social network, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities. According to some embodiments of the present disclosure, smart TV voice processing systems and methods are provided. FIG. 1 is a flow diagram of the voice processing process for smart TVs according to some embodiments of the present disclosure; as shown in FIG. 1, the process comprises at least the following steps:

In step S102, a smart TV initiates a wireless voice channel.

In some embodiments of the present disclosure, a smart TV refers to a terminal, equipped with an operating system, wherein software programs can be freely installed and uninstalled, and includes functions such as video-playing, entertainment, gaming, and the like; and the smart TV has a network connectivity through a cable or a wireless network card.

In some embodiments of the present disclosure, the smart TV initiates the wireless voice channel between the smart TV and a mobile terminal, wherein the mobile terminal can be a smart phone, a tablet PC (PAD), a PDA or other known or to be known smart terminal devices, as discussed above. The smart TV and the mobile terminal each has a wireless communication module, and the smart TV and the mobile terminal can realize a wireless communication connection through their respective wireless communication module, so as to establish the wireless voice channel between the smart TV and the mobile terminal, wherein the wireless communication module may be, for example, but is not limited to, a WIFI® module, a Bluetooth® module or a wireless USB® module, and the like; however, the present disclosure is not so limited and can include any other type of wireless communication module.

In step S104, the smart TV receives voice signals through the voice channel.

When the smart TV initiates the wireless voice channel between the smart TV and the mobile terminal, the smart TV receives the voice signals from the mobile terminal through the established voice channel. Prior to this step, the mobile terminal needs to acquire the voice signals in advance. A detailed account of how the mobile terminal acquires the voice signals is provided below.

In some embodiments of the present disclosure, the user inputs a voice signal through a microphone of the mobile terminal, the mobile terminal performs an analog-to-digital conversion and other processes after the microphone acquires an analog voice signal, and then a digital voice signal is transmitted to the smart TV through the voice channel. In this case, the mobile terminal achieves a virtual microphone function of the smart TV, and the mobile terminal can be regarded as the voice input device for the smart TV.

In some embodiments of the present disclosure, the mobile terminal stores a plurality of voice signals received in advance in other manners, or recorded in advance, and the user selects the desired voice signals from the plurality of stored voice signals and transmits the voice signals to the smart TV.

In step S106, the smart TV determines a current application scenario and correspondingly processes the voice signals according to the current application scenario.

In the present disclosure, the smart TV has a variety of application scenarios, for example, including, but not limited to, a video application scenario, an entertainment application scenario and other known or to be known application scenario of a smart TV. Furthermore, the video application scenario comprises, for example, basic cable and wireless TV functions, network TV, DVD video player, and other known or to be known scenarios; the entertainment application scenario comprises, for example, a karaoke function, a (video) chat function, and other known or to be known scenarios.

When it is determined that the current application scenario of the smart TV is the video application scenario (i.e., a first application scenario), the smart TV converts the voice signals into a corresponding operation command through voice recognition technology, and executes the operation command; specifically, in some embodiments, the operation command is an operation command of a remote controller of the smart TV, including, but not limited to, an on-off command, a volume adjustment command, a channel selection command, and the like.

The smart TV stores a voice feature database in advance, wherein the voice feature database may comprise a voice model. During voice recognition, a voice feature of the voice signal is extracted, and the voice feature is searched to find a match in the voice feature database, and the match result is converted into a corresponding operating instruction.

For example, when a user watches TV programs through the smart TV, the user may speak instructions such as “volume up”, “volume down” or “turn it up”, “turn it down” to adjust the volume of the TV. The user may also say “switch to another channel” to change the channel, or say “power on” or “power off” to control the power supply. The above sounds are acquired by the mobile phone and other mobile terminals and are transmitted to the smart TV through the voice channel; after receiving the voice signals, the smart TV extracts voice features therein and finds a match for the voice features in the voice feature database. The voice feature database stores corresponding relations between voice features and operation instructions, the corresponding operation instructions can be identified according to the voice features and are executed on the smart TV, so as to control the smart TV, wherein the voice features include, but are not limited to, voice cepstrum, logarithmic spectrum, spectrum, formant position, pitch, spectrum energy, and other characteristics.

Moreover, when it is determined that the current application scenario of the smart TV is the karaoke application scenario (i.e., a second application scenario), the smart TV recognizes the voice signals through the voice recognition technology and finds a match for the recognized voice signals in a preset database, so as to obtain the matching result, and then the matching result is executed by the smart TV. For example, when the smart TV implements the karaoke function, the user may say the name of a song or a singer or hums a melody to the mobile phone, the above sounds are acquired by the mobile phone or other mobile terminals, and then are transmitted to the smart TV through the voice channel; after receiving the voice signals, the smart TV extracts voice features therein and finds a match for the voice features in a preset song library; a song corresponding to the song name, the singer name or the melody is identified, and the song is played on the smart TV, so as to realize the effect of quickly finding the song.

In addition, when the smart TV executes the karaoke function, the user may use the mobile phone as an audio acquisition device of the smart TV and sings a song to the mobile phone; the above sound signal is acquired by the mobile phone or other mobile terminals, and then is transmitted to the smart TV through the voice channel; and the smart TV directly broadcasts the sound signal.

In the above embodiments, the mobile phone is used as the audio acquisition device of the smart TV, the voice recognition technology is used to control the smart TV and the voice input of the same, and the user can then interact with the smart TV directly through this portable device (the mobile phone), so as to greatly improve the user experience of the smart TV.

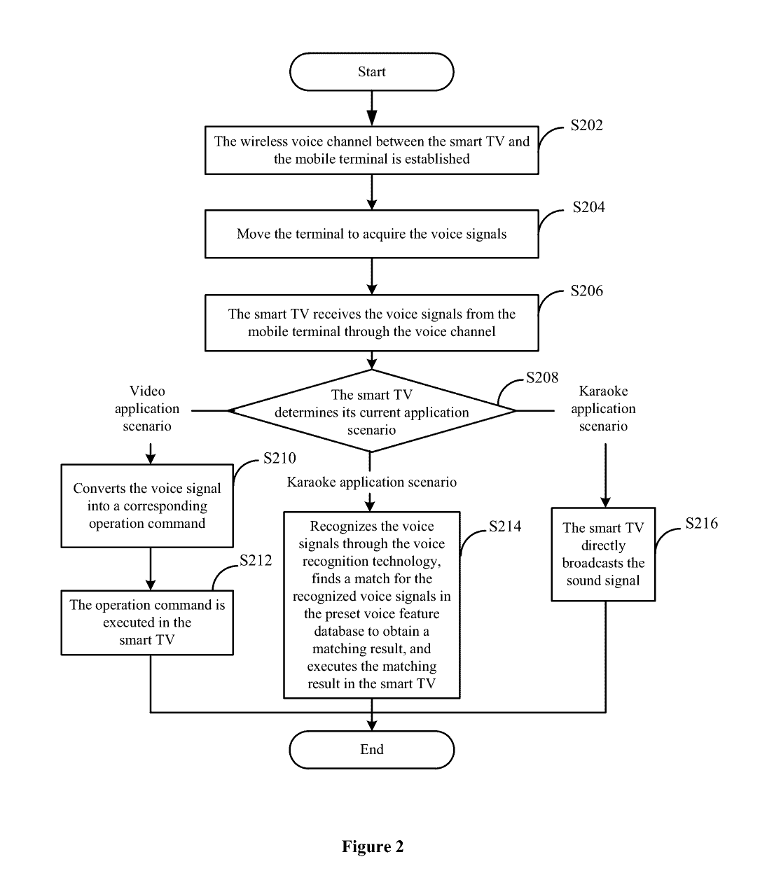

Some embodiments of the present disclosure are described in reference to FIG. 2, which comprises the following steps:

In step S202, the wireless voice channel between the smart TV and the mobile terminal is established.

In step S204, the mobile terminal acquires the voice signals, wherein the voice signals can be acquired through a microphone of the mobile terminal, or voice signals can be received in advance through the mobile terminal.

In step S206, the smart TV receives the voice signals from the mobile terminal through the voice channel.

In step S208, the smart TV receives the voice signals; the smart TV determines its current application scenario, if it determines that it is a video application scenario, step S210 will be executed; if the smart TV determines that it is a karaoke application scenario, step S214 or step S216 will be executed.

In step S210, when the smart TV is in the video application scenario, it converts the voice signal into a corresponding operation command.

In step S212, the operation command is executed by the smart TV.

In step S214, when the smart TV is in the karaoke application scenario, the smart TV recognizes the voice signals through the voice recognition technology, finds a match for the recognized voice signals in the preset voice feature database to obtain a matching result, and executes the matching result.

In step S216, when the smart TV is in the karaoke application scenario, it directly broadcasts the sound signal.

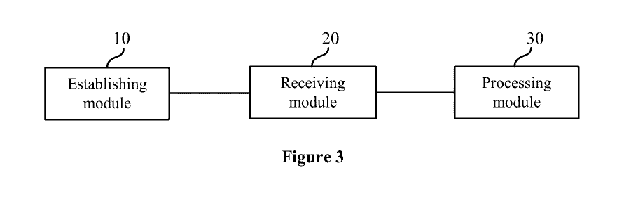

Referring to FIG. 3 below; FIG. 3 is a block diagram of the smart TV according to some embodiments of the present disclosure. FIG. 3 includes an establishing module 10, a receiving module 20, and a processing module 30. It should be understood that the modules discussed herein are non-exhaustive, as additional or fewer modules (or sub-modules) may be applicable to the embodiments of the disclosed systems and methods. The structure and connecting relationship of each module will be described in detail.

The establishing module 10 is used for initiating a wireless voice channel.

According to some embodiments, the establishing module 10 initiates the wireless voice channel between the smart TV and the mobile terminal. The smart TV and the mobile terminal each has a wireless communication module, the smart TV and the mobile terminal conduct wireless communication connections through their respective wireless communication module, so as to establish the wireless voice channel between the smart TV and the mobile terminal,

The receiving module 20 is used for receiving voice signals through the voice channel. When the smart TV initiates the wireless voice channel between the smart TV and the mobile terminal, the smart TV receives the voice signals from the mobile terminal through the established voice channel.

The processing module 30 is used for determining a current application scenario of the smart TV, and correspondingly processing the voice signals according to the current application scenario.

Further, if it is determined that the current application scenario of the smart TV is the video application scenario (i.e., a first application scenario), the processing module is used for recognizing the voice signals through the voice recognition technology, converting the recognized voice signal into a corresponding operation command, and executing the operation command via the smart TV; wherein, the operation command is an operation command corresponding to the remote control for the smart TV.

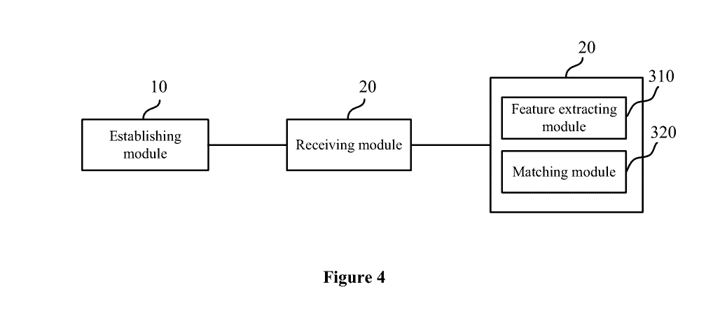

On this basis, with reference to FIG. 4, the processing module 30 further comprises:

a feature extracting module 310 used for extracting voice features of the voice signals; and

a matching module 320 used for finding a match for the voice features in a preset voice feature database to obtain a matching result, and converting the matching result into a corresponding operation instruction, wherein, the corresponding relations between voice features and operation instructions are stored in the voice feature database.

If it is determined that the current application scenario of the smart TV is the karaoke application scenario (namely, a second application scenario), the processing module is further used for recognizing the voice signals through the voice recognition technology, finding a match for the recognized voice signals in the preset voice feature database to obtain a matching result, and executing the matching result via the smart TV.

If it is determined that the current application scenario of the smart TV is a karaoke application scenario (i.e., a second application scenario), the voice signals will be played through the sound card of the smart TV.

The operating steps of the method of the present disclosure correspond to the structure features of the system, and can be mutually referenced.

In summary, according to the technical schemes of the present disclosure, voice signals are received through the established voice channel, and processing of the voice signals can be carried out according to the determined current application scenario, so as to realize the interaction with the smart TV and greatly improve the smart TV user experience.

In a typical configuration, the computing device comprises at least one or more CPUs, I/O interface, network interface and memory.

As discussed above, the memory may include volatile memory, random access memory (RAM) and/or NVRAM and other forms (such as read-only memory (ROM) or flash RAM) for the computer readable media. The memory is an example of non-transitory computer readable media.

The computer readable media include volatile, non-volatile, removable and non-removable media, which can realize information storage by any method or technology. The information can be computer readable and computer-executable instructions, data structure, program module or other data. The example of computer storage medium includes, but is not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read only memory (CD-ROM), digital versatile disc (DVD) or other optical storages, cassette magnetic tape, tape, disk storages or other magnetic memory devices or any other non-transmission media that can be used to store information accessible by the computing device. According to definitions herein, the computer readable media exclude transitory media, such as modulated data signal and carrier wave.

It shall be noted that the terms “comprising”, “including” or any other variations thereof are intended to cover a non-exclusive inclusion such that the process, method, article or device comprising a series of elements include not only those elements, but also other elements not expressly listed or the inherent elements of such process, method, commodity or device. In the absence of more restrictions, the elements defined by the sentence “comprise a” does not exclude the presence of other identical elements for the process, method, article or device comprising the elements.

A person skilled in the art shall understand that the embodiments of the present disclosure can be provided as method, system or computer program product. Accordingly, the present disclosure can adopt the form of an entire hardware embodiment, an entire software embodiment or the embodiment combining software and hardware. In addition, the present disclosure can take the form of computer program products that can be implemented on one or more computer usable storage media (including, but not limited to, disk storage device, CD-ROM and optical storage) containing computer readable program codes.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
establishing, via a smart television (TV), a wireless connection with a mobile device, said wireless connection comprising a voice channel that enables communication of data between the smart TV and the mobile device;
receiving, at the smart TV, voice signals from said mobile device over the established wireless connection;
analyzing, via the smart TV, the received voice signals comprising identifying information within said voice signals;
determining, via the smart TV, an application scenario associated with said voice signals; and
processing, via the smart TV, said voice signals according to said application scenario.

2. The method of claim 1, wherein said voice signal comprises an operation command requested by a user,
wherein analyzing the received voice signals comprises identifying said operation command from said voice signals, said analysis comprising the smart TV identifying information within said voice signals that corresponds to said operation command, and
wherein processing said voice signals comprises executing the operation command based on said application scenario, said execution on the smart TV resulting in said smart TV rendering content according to said application scenario.

3. The method of claim 2, wherein said application scenario comprises a video application stored on said smart TV for rendering said content.

4. The method of claim 3, further comprising:
extracting voice features from the received voice signals;
converting the extracted voice features into said operation command; and
executing the operation command on the smart TV via the video application.

5. The method of claim 2, wherein said application scenario comprises a karaoke application stored on said smart TV for rendering said content.

6. The method of claim 5, further comprising:
executing voice recognition technology in order to identify said information within said voice signals;
searching a voice feature database using the identified information as a query in order to identify a matching result in the voice feature database that corresponds to said operation command;
executing said identified matching result on the smart TV via the karaoke application.

7. The method of claim 6, wherein said voice feature database is pre-populated with voice features prior to the establishing said wireless connection, wherein said voice features are stored in association with a set of operation commands.

8. The method of claim 2, wherein said operation command comprises commands for remotely controlling said smart TV via voice instructions input by the user through the mobile device.

9. The method of claim 1, wherein said voice signals are acquired by the mobile device before the establishment of the wireless connection.

10. The method of claim 9, wherein said voice signals are formatted as digital voice signals based on a previously performed analog-to-digital conversion applied by the mobile device.

11. A non-transitory computer-readable storage medium tangibly encoded with computer executable instructions, that when executed by a processor of a smart television (TV), perform a method comprising:
establishing a wireless connection with a mobile device, said wireless connection comprising a voice channel that enables communication of data between the smart TV and the mobile device;
receiving voice signals from said mobile device over the established wireless connection;
analyzing the received voice signals comprising identifying information within said voice signals;
determining an application scenario associated with said voice signals; and
processing said voice signals according to said application scenario.

12. The non-transitory computer-readable storage medium of claim 11, said voice signal comprising an operation command requested by a user, the method performed when said instructions are executed further comprising
analyzing the received voice signals comprises identifying said operation command from said voice signals, said analysis comprising the smart TV identifying information within said voice signals that corresponds to said operation command, and
processing said voice signals comprises executing the operation command based on said application scenario, said execution on the smart TV resulting in said smart TV rendering content according to said application scenario.

13. The non-transitory computer-readable storage medium of claim 12, wherein said application scenario comprises a video application stored on said smart TV for rendering said content.

14. The non-transitory computer-readable storage medium of claim 13, the method performed when said instructions are executed further comprising:
extracting voice features from the received voice signals;
converting the extracted voice features into said operation command; and
executing the operation command on the smart TV via the video application.

15. The non-transitory computer-readable storage medium of claim 10, wherein said application scenario comprises a karaoke application stored on said smart TV for rendering said content.

16. The non-transitory computer-readable storage medium of claim 15, the method performed when said instructions are executed further comprising:
executing voice recognition technology in order to identify said information within said voice signals;
searching a voice feature database using the identified information as a query in order to identify a matching result in the voice feature database that corresponds to said operation command;
executing said identified matching result on the smart TV via the karaoke application.

17. The non-transitory computer-readable storage medium of claim 16, wherein said voice feature database is pre-populated with voice features prior to the establishing said wireless connection, wherein said voice features are stored in association with a set of operation commands.

18. The non-transitory computer-readable storage medium of claim 12, wherein said operation command comprises commands for remotely controlling said smart TV via voice instructions input by the user through the mobile device.

19. The non-transitory computer-readable storage medium of claim 11, wherein said voice signals are acquired by the mobile device before the establishment of the wireless connection, wherein said voice signals are formatted as digital voice signals based on a previously performed analog-to-digital conversion applied by the mobile device.

20. A system comprising:
a processor;
a non-transitory computer-readable storage medium for tangibly storing thereon program logic for execution by the processor, the program logic comprising:
logic executed by a processor for establishing, via a smart television (TV), a wireless connection with a mobile device, said wireless connection comprising a voice channel that enables communication of data between the smart TV and the mobile device;
logic executed by a processor for receiving, at the smart TV, voice signals from said mobile device over the established wireless connection;
logic executed by a processor for analyzing, via the smart TV, the received voice signals comprising identifying information within said voice signals;
logic executed by a processor for determining, via the smart TV, an application scenario associated with said voice signals; and
logic executed by a processor for processing, via the smart TV, said voice signals according to said application scenario.

21. The system of claim 20, further comprising logic for determining that said voice signal comprises an operation command requested by a user,
the logic for analyzing the received voice signals further comprises logic to identify said operation command from said voice signals, said analysis comprising the smart TV identifying information within said voice signals that corresponds to said operation command, and
the logic for processing said voice signals further comprises logic for executing the operation command based on said application scenario, said execution on the smart TV resulting in said smart TV rendering content according to said application scenario.

22. The system of claim 21, further comprising:
logic for extracting voice features from the received voice signals;
logic for converting the extracted voice features into said operation command; and
logic for executing the operation command on the smart TV via a stored video application, wherein said video application is stored on said smart TV for rendering said content.

23. The system of claim 21, further comprising:
logic for executing voice recognition technology in order to identify said information within said voice signals;
logic for searching a voice feature database using the identified information as a query in order to identify a matching result in the voice feature database that corresponds to said operation command; and
logic for executing said identified matching result on the smart TV via a stored karaoke application, wherein said karaoke application is stored on said smart TV for rendering said content.

24. The method of claim 1, wherein said application scenario comprises a karaoke application stored on said smart TV for broadcasting said voice signal from said smart TV.
